(19) United States
(12) Patent Application Publication
(10) Pub. No.: US 2010/0313717 A1
(43) Pub. Date: Dec. 16, 2010

(54) MULTI-FUNCTIONAL TOOL HANDLE

(76) Inventor: Chun-Yong CHEN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/483,833

(22) Filed: Jun. 12, 2009

(51) Int. Cl. B25G 1/08

(52) U.S. Cl. 81/490

(57) ABSTRACT

A multi-functional tool handle comprises a handle main body, a fixing seat, and a set of head tips. The handle main body is provided with a receiving groove therein for locating the head-tip set. The rear end of the handle main body is provided with a recessed groove for connection with an engaging part of the fixing seat. The engaging part is provided with and engaging groove and a fixing hole that are in communication with each other. Besides, the rear end of the handle main body is provided with an arm that is located in the recessed groove. One end of the arm passes through the engaging groove and extends into the fixing hole. Consequently, when a head tip is inserted into the fixing hole, the head tip can be pressed by the arm and thus positioned in the fixing hole.

### TECHNICAL FIELD

The present invention relates to a tool handle, and more particularly to a multi-functional tool handle that can be used as a conventional tool handle, for storing a head-tip set, and has a fixing structure for effectively positioning a head tip.

### BACKGROUND

There are many chances to use handles of various hand tools, such as iron hammers, screwdrivers etc. for repairing failed articles. Particularly, a user can enjoy the fun of DIY in using a hand tool that can be used to save fees for repairing.

Kinds of handles of hand tools are numerous and what people use most frequently are screwdrivers that can be used to screw on or off screws. Users may use screwdrivers to screw on or off screws of things as small as a watch or a cell phone and as large as a building of steel may use. Different screwdrivers are required for different head tips. For instance, common Phillips screws are screwed off with Phillips head tips and screw heads with hexagonal recesses are screwed off with hexagonal head tips. Particularly, since depths of the recesses on different screw heads vary, it is required to use a suitable screwdriver for one kind of head tip. Thereby, there have been various screwdrivers in the industry for users to choose.

Screwdrivers are widely used and nearly all kinds of engineering work need them. Therefore, in the conventional techniques, screwdrivers are designed to connect the head tips directly on the bottom of handles of hand tools. The advantage of such structure is to have two functions. However, each structure is suitable for one kind of head tip and thus the utility thereof is limited. Therefore, the inventor of the present invention provides a tool handle that can be used as a screwdriver and can be used to store various kinds of head tips.

Refer to FIGS. 8-10 that show a granted US patent with patent number U.S. Pat. No. 7,121,173 and owned by the inventor of the present invention. As shown in these figures, the tool handle “a” has a handle main body “a1”. The handle main body “a1” is provided with a receiving groove “a2” therein for locating a head-hip set “c” storing a plurality of head tips “b”. A L-shape stop member “d” is provided and has a flat part “d1”. The flat part “d1” is connected to the bottom of a fixing seat “e”. The L-shape stop member “d” can be positioned when the bottom of a head tip “b” is against the flat part “d1” of the L-shape stop member “d”. After that, one end of the L-shape stop member “d” is against the head tip “b” and the head tip “d” can be positioned.

By using above structure, various kinds of head tips can be stored in the tool handle and a head tip can be positioned firmly for convenient use. However, when a head-tip set is stored within the receiving groove of the handle main body of the tool handle, it is unable for users to know the actual kinds and number of the head tips and thus it becomes uncertain to users. Moreover, since the L-shape stop member is a curved metal strip, there may exist disadvantages including elastic fatigue and rustiness, increasingly processing time and cost, and increasingly manufacturing time. Therefore, above structure needs to be further improved.

In order to overcome above shortcomings, inventor had the motive to study and develop the present invention. After hard research and development, the inventor provides a multi-functional tool handle having advantages of simple structure, lower manufacturing and assembling cost, and convenient use.

### SUMMARY OF THE DISCLOSURE

An objective of the present invention is to provide a multi-functional tool handle, where an arm is formed integrally with a handle main body, so that a head tip can be effectively positioned and the manufacturing and assembling cost can be reduced.

Another objective of the present invention is to provide a multi-functional tool handle, where a plate pervious to light is provided at the upper end of the handle main body, so that users can know the number and the kinds of the head tips stored therein by seeing through the plate.

In order to achieve the above objectives, the present invention provides a multi-functional tool handle comprising a handle main body. The handle main body is provided with a receiving groove therein for locating a head-tip set. The rear end of the handle main body is connected with a fixing seat. The fixing seat is provided with an engaging part and the rear end of the engaging part is provided with a fixing hole for inserting a head tip therein. The multi-functional tool handle is characterized in that: the engaging part of the fixing seat is provided with an engaging groove and the engaging groove is in communication with the fixing hole. The rear end of the handle main body is provided with a recessed groove for positioning the engaging part. An arm is provided at the rear end of the handle main body and is located in the recessed groove. One end of the arm passes through the engaging groove and extends into the fixing hole, so that the head tip can be pressed by the arm and thus positioned when the head tip is inserted into the fixing hole.

In practice, the upper end of the handle main body is provided with a hole that is in communication with the receiving groove and a plate pervious to light is positioned on the hole for seeing the head-tip set therein.

The following detailed description, given by way of examples or embodiments, will best be understood in conjunction with the accompanying drawings.

### BRIEF DESCRIPTION OF THE DRAWINGS

FIG. 1 is a perspective view of an embodiment of the present invention.

FIG. 2 is a perspective view of the embodiment of the present invention viewed from another angle.

FIG. 3 is an exploded perspective view of the embodiment of the present invention.

FIG. 4 is a sectional view taken along line A-A′ of FIG. 1.

FIG. 5 is a sectional view taken along line B-B′ of FIG. 1.

FIG. 6 is a sectional view of the embodiment of the present invention before a head tip is connected to a fixing seat.

FIG. 7 is a sectional view of the embodiment of the present invention after the head tip is connected to the fixing seat.

FIG. 8 is an exploded perspective view of a conventional tool handle.

FIG. 9 is a sectional view of the conventional tool handle before a head tip is connected to a fixing seat.

FIG. 10 is a sectional view of the conventional tool handle after the head tip is connected to the fixing seat.

### DETAILED DESCRIPTION

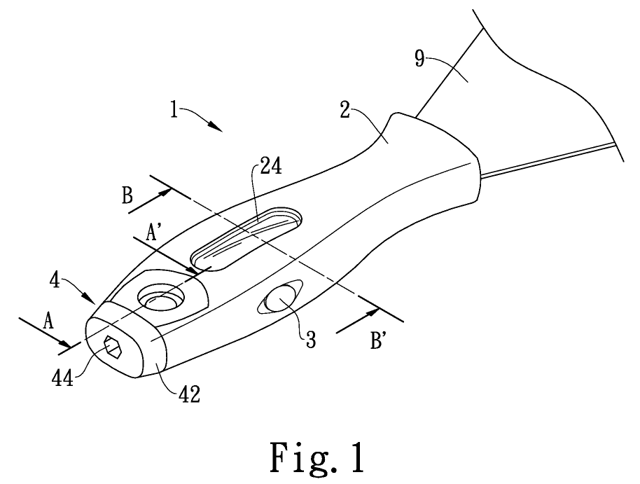

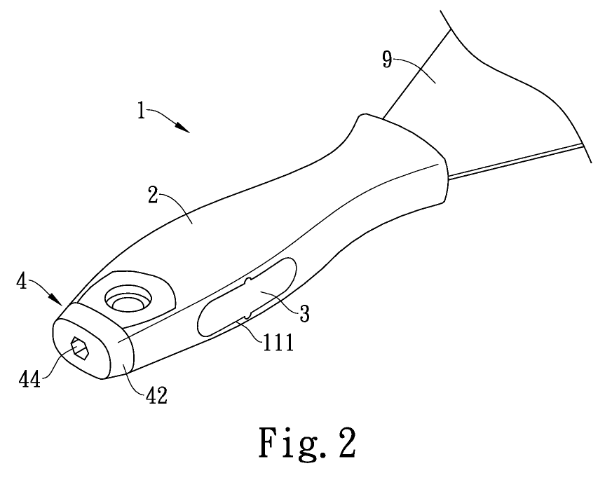

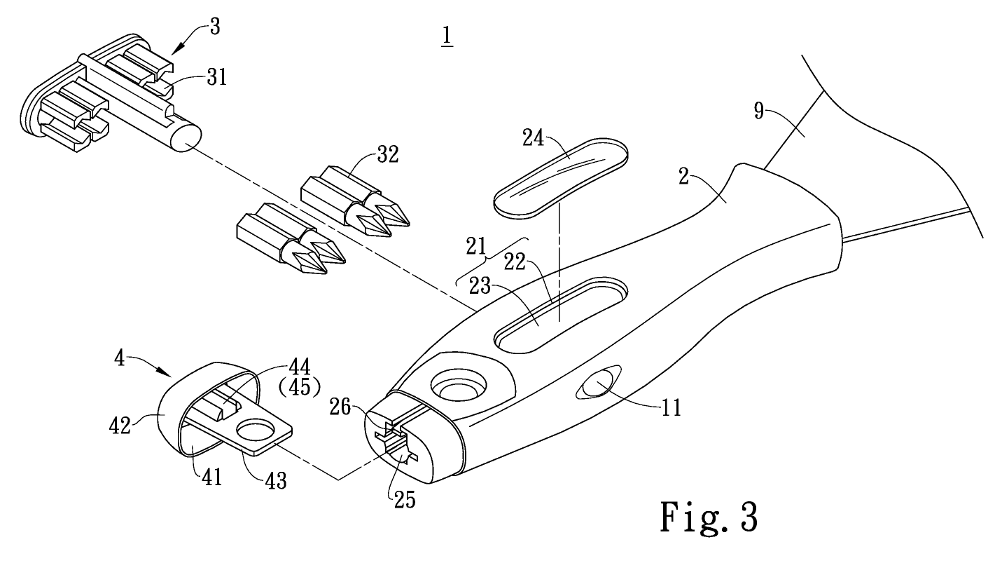

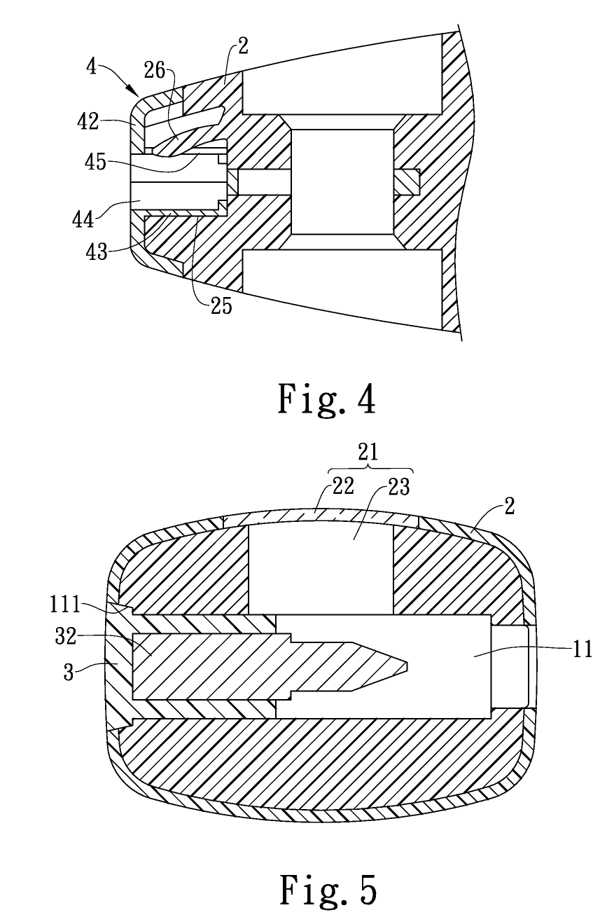

Referring to FIGS. 1-5 showing a multi-functional tool handle 1 of an embodiment of the present invention. The multifunctional tool handle 1 comprises a handle main body 2, a head-tip set 3, and a fixing seat 4.

The front end of the handle main body 2 can be used to connect with a tool blade 9. The middle section of the handle main body 2 is provided with a substantially rectangular receiving groove 11 therein. One end of the receiving groove 11 is provided with an opening 111. A substantially rectangular head-tip set 3 can be inserted into the receiving groove 11 via the opening 111. The head-tip set 3 has plural pairs of holding parts 31 for holding a plurality of head tips 32.

A long step aperture 21 is provided at the upper end of the middle section of the handle main body 2. The step aperture 21 includes an upper part 22 with a larger diameter and a lower part 23 with a smaller diameter and the lower part 23 is in communication with the upper part 22. The upper and the lower parts 22, 23 of the aperture 21 are in communication with the receiving groove 11. A long plate pervious to light 24 can be correspondingly connected to the upper part 22, so that users can see the kinds and number of head tips 32 stored in the handle main body 2 via the plate pervious to light 24.

Moreover, a substantially rectangular recessed groove 25 is formed at the rear end of the handle main body 2. Besides, a curved arm 26 and the handle main body 2 are formed in a one-piece structure integrally. Specifically, the handle main body 2 and the arm 26 that are formed in a one-piece structure integrally are produced by means of plastic injection molding, where the arm 26 extends from the bottom of the recessed groove 25 along a curve and is located in the recessed groove 25.

The fixing seat 4 includes a case 42 with an opening 41 and an engaging part 43. The engaging part 43 extends from the inner bottom of the case 42 toward the opening 41 and the rear end of the engaging part 43 is provided with a hexagonal fixing hole 44 for inserting a head tip 32 with a corresponding shape therein. A substantially rectangular engaging groove 45 is formed at the upper end of the engaging part 43. The engaging groove is in communication with the fixing hole 44 and is located on one side of the hexagonal fixing hole 44.

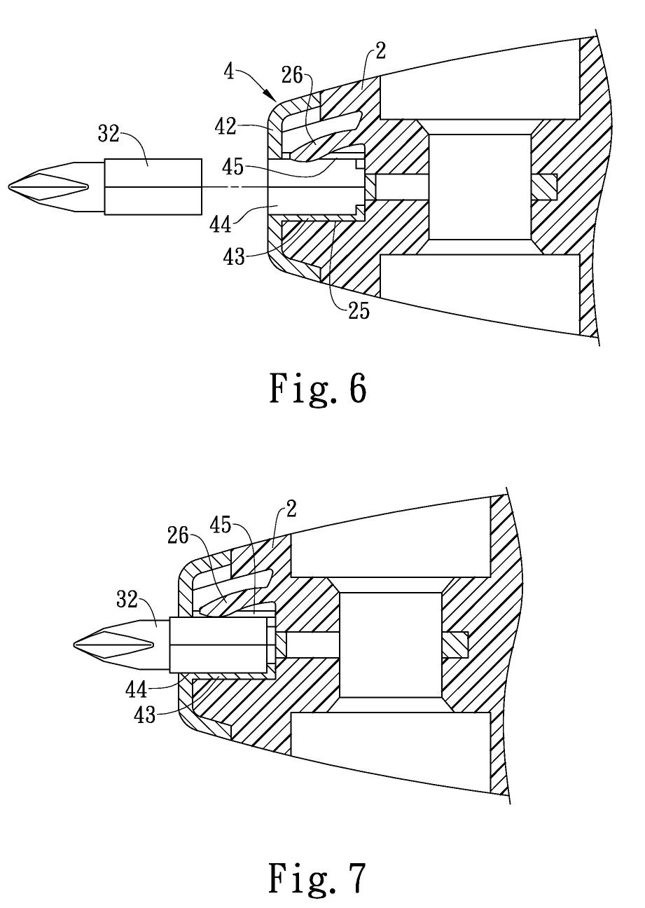

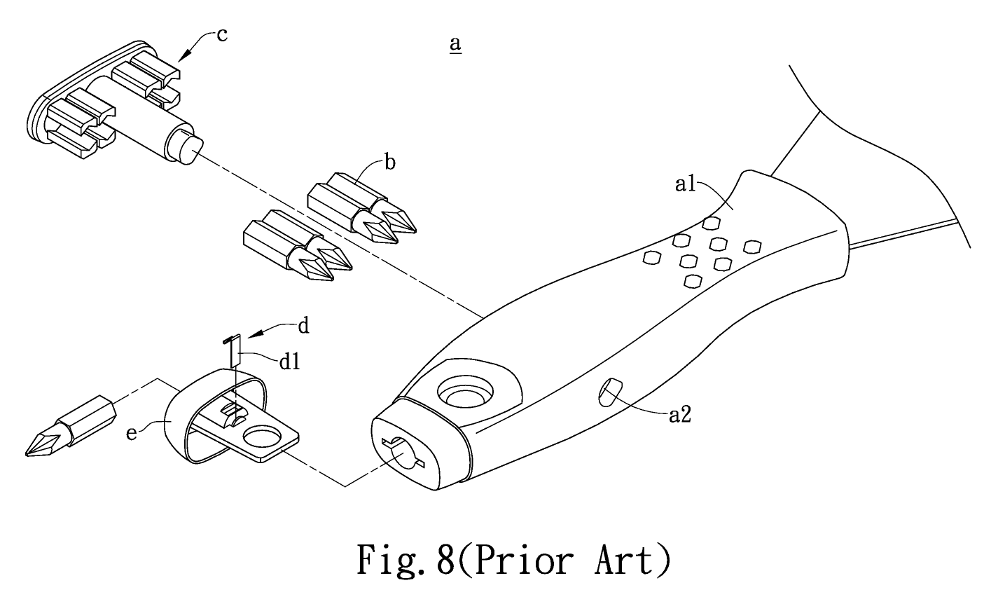

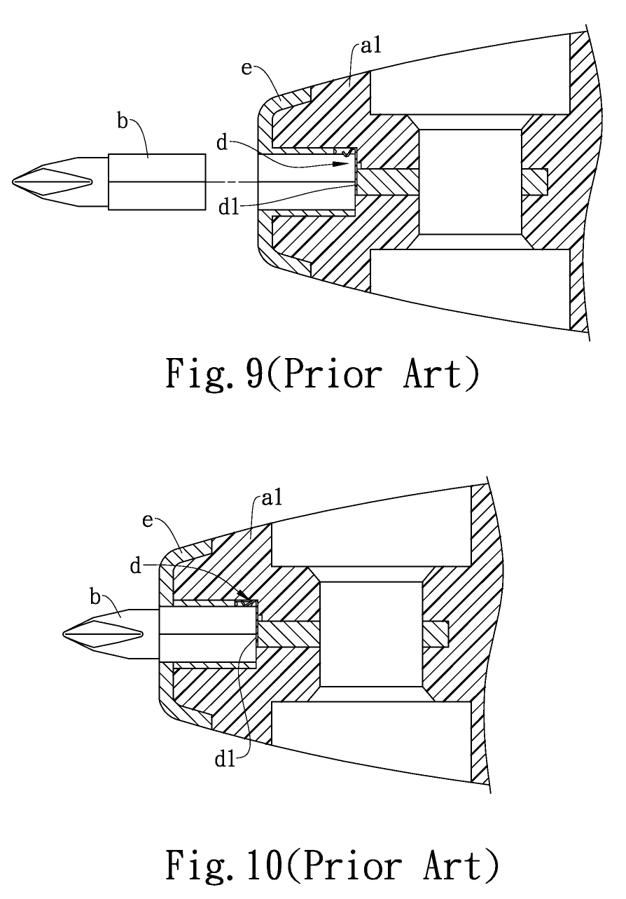

Please refer to FIG. 6, when the case 42 of the fixing seat 4 covers the rear end surface of the handle main body 2 and the engaging part 43 of the fixing seat 4 is located and positioned in the recessed groove 25 at the rear end of the handle main body 2, the free end of the arm 26 passes through the engaging groove 45 and extends into the fixing hole 44. As shown in FIG. 7, when the head tip 32 is inserted into the fixing hole 44 at the rear end of the engaging part 43, one side of the hexagonal head tip that faces upward will push and move the free end of the arm 26 upward. The restoring force produced by the upward moved arm 26 will be exerted on one side of the head tip 32, so that the head tip 32 can be firmly connected with the handle main body without being detached there from.

In practice, two arms 26 can be provided and located symmetrically corresponding to two lateral sides of the recessed groove 25. Besides, two engaging parts 43 can be provided for correspondingly inserting the two arms 26 therein respectively. By this way, a head tip 32 also can be positioned.

The present invention has the following advantages:

1. The present invention can be used as a screwdriver as well as a conventional tool handle. Besides, the present invention also can be used in other different applications when different kinds of head tips are used. Therefore, the present invention can be used widely and elastically.

2. By means of the design of the arm according to the present invention, a head tip can be positioned effectively after being inserted into the fixing hole. Therefore, it can prevent from the inconvenience resulted from the detachment of the head tip when in use.

3. The arm and the handle main body according to the present invention are formed in a one-piece structure integrally. Therefore, the whole structure of the present invention can be simplified, the material cost can be saved, and the processing, manufacturing, and manual assembling cost can be reduced effectively.

4. The arm according to the present invention is produced by means of plastic injection molding, so that the problem resulted from elastic fatigue and rustiness of conventional metal stop member can be effectively prevented. Therefore, the arm can be used to position a head tip effectively and the lifetime thereof can be lengthened.

As disclosed in the above description and attached drawings, the present invention can provide a multi-functional tool handle that has simple structure and reduced manufacturing and assembling cost and can be used conveniently. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A multi-functional tool handle comprising a handle main body, where the handle main body is provided with a receiving groove therein for locating a head-tip set; the rear end of the handle main body is connected with a fixing seat; the fixing seat is provided with an engaging part and the rear end of the engaging part is provided with a fixing hole for inserting a head tip therein; the multi-functional tool handle is characterized in that:
the engaging part of the fixing seat is provided with an engaging groove and the engaging groove is in communication with the fixing hole;
the rear end of the handle main body is provided with a recessed groove for positioning the engaging part and is provided with an arm that is located in the recessed groove, where one end of the arm passes through the engaging groove and extends into the fixing hole, so that the head tip can be pressed by the arm and thus positioned when the head tip is inserted into the fixing hole.

2. The multi-functional tool handle as claimed in claim 1, wherein the upper end of the handle main body is provided with a hole that is in communication with the receiving groove and a plate pervious to light is positioned on the hole for users to see the head-tip set therein.

3. The multi-functional tool handle as claimed in claim 1, wherein the handle main body and the arm are formed in a one-piece structure integrally.

4. The multi-functional tool handle as claimed in claim 3, wherein the handle main body and the arm that are formed in a one-piece structure integrally are produced by means of plastic injection molding.

5. The multi-functional tool handle as claimed in claim 1, wherein the fixing hole and the head tip are in corresponding hexagonal shape and the engaging groove is formed at one side of the hexagonal fixing hole for inserting one end of the arm there through to be against one side of the hexagonal head tip.
